(19) United States
(12) Patent Application Publication
(10) Pub. No.: US 2009/0030706 A1
(43) Pub. Date: Jan. 29, 2009

(54) Method and System for Enhanced Cross-Team Change Request Management

(76) Inventors: Geoffrey D. Alexander, Chapel Hill, NC (US); Andrew J. Berner, Irving, TX (US); Brianna M. Smith, Westminster, CO (US); Douglas A. Williams, Durham, NC (US)

Correspondence Address: DILLON & YUDELL LLP, 8911 N. CAPITAL OF TEXAS HWY., SUITE 2110, AUSTIN, TX, 78759, US

(21) Appl. No.: 11/781,339

(22) Filed: Jul. 23, 2007

(51) Int. Cl. G06Q 10/00

(52) U.S. Cl. 705/1

(57) ABSTRACT

In a data processing system having multiple logically coupled branch systems that share interdependent products and services, a system for providing enhanced cross-team change request management. In one embodiment, the system includes a consumer branch system that generates a consumer change request. A trunk system manages cross-team change requests between the branch systems in a shared database and stores a first cross-team change request that associates the consumer change request with a first provider branch system. In response to the first provider branch system determining that a supplemental consumer change request is required to address the first consumer change request, the first provider branch system generates a second cross-team change request within the trunk system. The second cross-team change request associates the supplemental consumer change request with a second provider branch system.

### BACKGROUND OF THE INVENTION

1. Technical Field

The present invention relates generally to cross-team change request management in a multi-component system, and in particular, to an architecture for cross-team change request management that uses a trunk system to connect multiple consumer and provider components.

2. Description of the Related Art

Today's software development includes a significant interdependency of software components and products. Exemplary of current multi-component systems having many critical interdependencies is the IBM® WebSphere® Application Server which provides scalable and resilient multi-component application infrastructure. The component interdependencies inevitably leads to a “consumer” of a component or product placing cross-team change requests, such as requests for defect fixes or enhancements (also referred to as requirements), on the “provider” of the component or product. As utilized herein a change request is generally a request for any kind of change in a product or service issued by a provider such as in response to a defect. As an example, consider IBM WebSphere Portal Server (WPS), which has dependencies on numerous other products such as IBM WebSphere Application Server (WAS) and IBM Database2 (DB2). Responsive to a WPS customer reporting a problem with WPS, a defect request is initiated in a WPS defect request handling entity. The WPS defect request handling entity may determine that there are defects in WAS and DB2 that must be addressed as part of addressing the reported WPS defect. Individually or in cooperation with WAS and DB2 defect request servicing entities, the WPS defect request handling entity opens two distinct defect requests—one in the WAS defect request service system and one in the DB2 defect request service system. In this scenario, the WPS service request resources or team, is a consumer of WAS and DB2, which are “providers” as utilized herein.

In most cases, the consumer uses the change request tracking system of the provider to open change requests. The provider's change request tracking system usually differs from that of the consumer, thus requiring the management of cross-team change requests in both consumers' and providers' tracking systems. Furthermore, the tracking system software used by a provider may differ from that used by a consumer, thus requiring the consumer to install and learn the provider's tracking system software. This becomes quite onerous when a consumer has dependencies on multiple providers. To complicate matters even further, in many cases consumers and providers use different systems to track their defects and enhancement requests.

Referring again to the above example of a change request originating from WPS service, the service and planning engineers of a product must be familiar with the change request (defect and/or enhancement) processes of many if not all of the products on which their own product(s) depend. This can be onerous when a product depends on a large number of other products, and in the WPS example, results in the WPS consumers having to be familiar with the change request processes for both WAS and DB2 and leaves unresolved how the WPS consumer tracks dependencies between the WPS defect and the WAS and DB2 defects.

It can therefore be appreciated that a need exists for a method, system, and computer program product for enhanced cross-team request management. The present invention addresses this and other needs unresolved by the prior art.

### SUMMARY OF THE INVENTION

In a data processing system having multiple logically coupled branch systems that share interdependent products and services, a system for providing enhanced cross-team change request management is disclosed herein. In one embodiment, the system includes a consumer branch system that generates a consumer change request. A trunk system manages cross-team change requests between the branch systems in a shared database and stores a first cross-team change request that associates the consumer change request with a first provider branch system. In response to the first provider branch system determining that a supplemental consumer change request is required to address the first consumer change request, the first provider branch system generates a second cross-team change request within the trunk system. The second cross-team change request associates the supplemental consumer change request with a second provider branch system.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting an exemplary cross-team change request configuration in accordance with the present invention;

FIG. 2 is a block diagram illustrating a many-to-many cross-team change request configuration in accordance with the present invention;

FIG. 3 is a block diagram depicting a cascaded cross-team change request configuration in accordance with the present invention;

FIG. 4 is a block diagram illustrating a transfer cross-team change request configuration in accordance with the present invention;

FIG. 5 is a block diagram depicting a subcontract cross-team change request configuration in accordance with the present invention; and

FIG. 6 is a block diagram illustrating a duplicate cross-team change request configuration in accordance with the present invention.

### DETAILED DESCRIPTION OF ILLUSTRATIVE EMBODIMENT(S)

In various embodiments, the invention is directed to an improved method, system, and computer program for cross-team change request management that uses a trunk system architecture to logically couple individual consumer and provider branch systems. Cross-team change requests in the trunk system are linked with change requests in consumer and provider branch systems. A communication subsystem provides an interface for transferring cross-team change request data between the trunk system and branch systems.

In a preferred embodiment of the cross-team change request architecture, the trunk system manages the cross-team change requests in a shared database. This provides an aggregation of cross-team change requests that allows for simple report generation and capturing of metrics. In addition, it greatly reduces the number of systems that a consumer or provider is required to work with in processing cross-team change requests and significantly reduces the number of required mappings between system components. Another benefit is that of common cross-team change processes among the consumers and providers.

In another aspect, the cross-team change request in the trunk system can be used to implement and manage a cross-team change negotiation. Some items that could be “negotiated” between the consumer and provider could be the design and scope of the change and the target design and delivery dates for the change.

As the provider team updates change request information in their respective branch system, the updated information can automatically be shadowed to a consumer team's change request in their branch system via the cross-team change request in the trunk system. In this way, members of the consumer team would automatically see provider information updates in their own branch system without the need to access the provider's branch system or to request information from a member of the provider team.

The system of the invention can define and enforce a cross-team change request process. For example, the system may require that all associated provider change requests be closed in the provider's branch system before allowing a consumer change request to be closed in the consumer's branch system.

Another aspect of a preferred embodiment is that the logical connective relationships between consumer and provider change requests are many-to-many. That is, a consumer may open many cross-team change requests to different providers for a single consumer branch request and a provider may link a single provider branch request to many cross-team change requests from different consumers as depicted and explained in further detail with reference to the following embodiments.

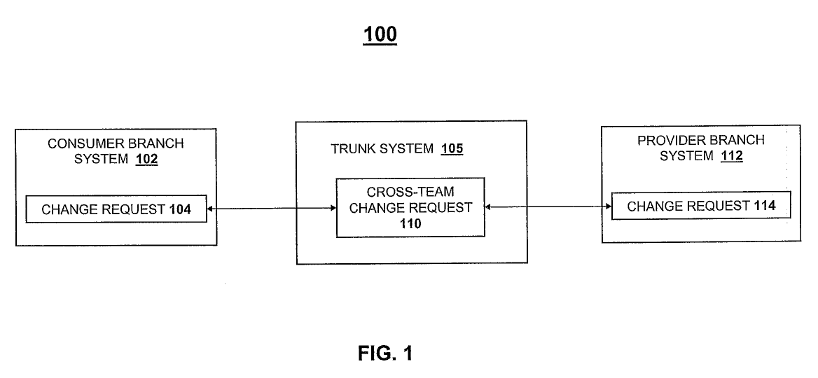

Referring now to the figures, wherein like reference numerals refer to like and corresponding parts throughout, and in particular with reference to FIG. 1, there is illustrated a block diagram depicting an exemplary cross-team change request architecture 100 in accordance with one embodiment of the present invention. The depicted cross-team change request architecture 100 is a dynamically generated logical assembly. Cross-team change request architecture 100 generally comprising a consumer branch system 102 logically coupled to a provider branch system 112 via a trunk system 105. The cooperative generation and interaction of the various components in the depicted embodiment is now explained.

In the simplest embodiment shown in FIG. 1, a consumer team member and/or processing unit within consumer branch system 102 opens or generates change request 104 within consumer branch system 102. The consumer team member then opens or generates a cross-team change request 110 within trunk system 105 specifying the consumer-side and provider-side team members and associating cross-team change request 110 with consumer change request 104. In one embodiment, trunk system 105 comprises a shared database that maintains and provides shared access to cross-team change requests such as cross-team change request 110.

Responsive to detecting cross-team change request 110, a provider team member/processing unit opens or generates change request 114 within provider branch system 112 and associates the change request 114 with cross-team change request 110. It should be noted that the consumer change request 104 within consumer branch system 102 is now logically linked to provider change request 114 within provider branch system 112 via the cross-team change request 110 within trunk system 105.

Consumer branch system 102 is automatically informed of provider progress in processing the cross-team change request 110 as follows. As provider branch system 112 updates status in change request 114, the updated status is automatically shadowed/written to the associated cross-team change request 110. Trunk system 105 then copies the updated status by updating the associated consumer-side change request 104 using updated cross-team change request 110.

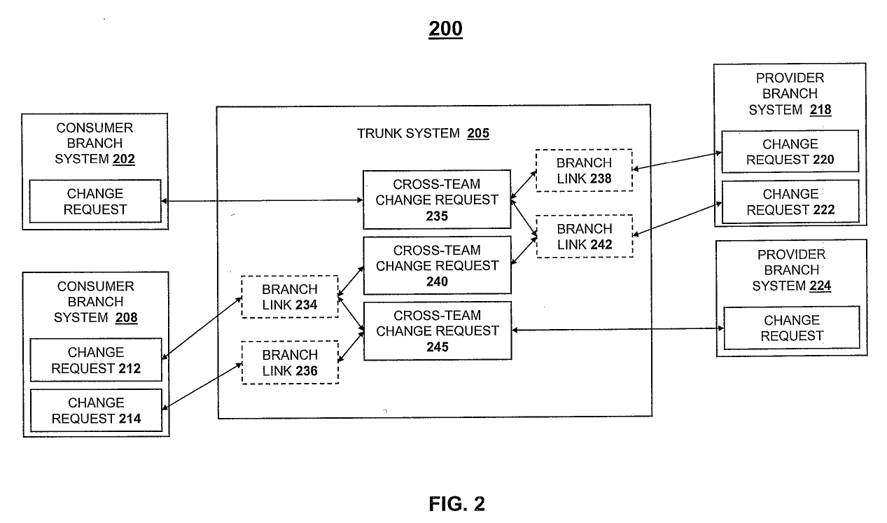

FIG. 2 is a block diagram illustrating a many-to-many cross-team change request architecture 200 in accordance with the present invention. As shown in FIG. 2, the architecture generally comprises consumer branch systems 202 and 208 having generated multiple change requests that are interfaced by a trunk system 205 with provider branch systems 218 and 224.

Expanding on the embodiment shown in FIG. 1, cross-team change request architecture 200 accommodates a many-to-many interfacing relationship between consumer branch system change requests and provider branch system change requests. In the depicted embodiment, a consumer such as consumer branch system 208 may link multiple consumer branch system change requests 212 and 214 to one or more of cross-team change requests 240 and 245 using corresponding consumer-side branch links such as consumer-side branch links 234 and 236. Namely, responsive to generation of change requests 212 and 214, a reference copy of change requests 212 and 214, in the form of consumer-side branch links 234 and 236 are automatically generated and stored within the shared database of trunk system 205. The consumer-side branch links are data structures such as stub objects that are generated by the subsystem components within trunk system 205 and that replicate and provide logical association between change requests 212 and 214 and cross-team change requests 240 and 245 responsive to the change requests 212 and 214 being received from consumer branch system 208. As shown in FIG. 2, consumer-side branch link 234 enables consumer branch system 208 to link a single consumer branch system change request such as change request 212 to multiple cross-team change requests such as cross-team change requests 240 and 245. It should be noted that while the embodiment shown in FIG. 2 illustrates use of branch links, such branch links may not be required such as shown in the embodiment depicted in FIG. 1.

Similarly, a provider such as provider branch system 218 may link multiple provider branch system change requests such as change requests 220 and 222 to a single cross-team change request such as cross-team change request 235 using a corresponding set of provider-side branch links 238 and 242. Furthermore, a provider such as provider branch system 218 may utilize alternate mappings between provider-side branch links and cross-team change requests to link a single provider branch system change request such as change request 222 to multiple cross-team change requests such as cross-team change requests 235 and 240.

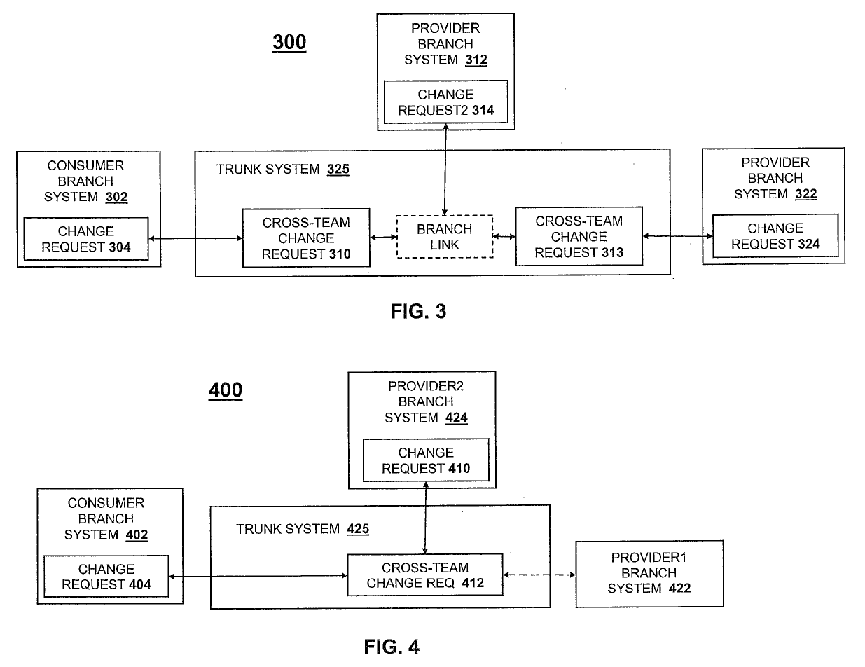

FIG. 3 is a block diagram depicting a cross-team change request architecture in accordance with an alternate embodiment of the present invention. Specifically, FIG. 3 illustrates a cascaded cross-team change request architecture 300 in which a trunk system 325 includes multiple cross-team change requests 310 and 313 for interfacing a consumer change request 304 with provider branch systems 312 and 322, respectively.

In accordance with the depicted embodiment, a team member or processing entity within consumer branch system 302 generates consumer change request 304 and also generates a cross-team change request 310 directed to provider branch system 312. To provide the requested change (i.e. satisfy the subject request contained in change request 310), provider branch system 312 opens or generates a cross-team change request 314. Provider branch system 312 may determine that an additional, supplemental consumer request should be generated and sent to provider branch 322. In response to determining that such a supplemental request should be directed to provider branch 322, provider branch system 312 simulates a consumer branch system and a team member or processing entity within provider branch system 312 generates and sends a supplemental cross-team change request 313 to provider branch system 322. The first cross-team change request 310 is thus “cascaded” with the second cross-team change request 313. In this manner, the cascaded cross-team change request architecture 300 enables the originally requested provider (i.e., provider branch system 312) to generate consumer requests associated with handling the original cross-team change request 310 that will be handled by additional providers (i.e., provider branch system 322).

FIG. 4 is a block diagram illustrating a cross-team change request architecture in accordance with the present invention. Specifically, FIG. 4 depicts a transfer cross-team change request architecture 400 generally comprising a consumer branch system 402 and provider1 branch system 422 interfaced via a trunk system 425. In the depicted embodiment, consumer branch system 402 generates a change request 404 and issues a corresponding cross-team change request 412 designating provider1 branch system 422 as the provider. In response to analyzing and otherwise processing the request, provider1 branch system 422 determines that the branch system is not the correct recipient of the change request. In this case, provider1 branch system 422 re-generates or otherwise modifies the cross-team change request 412 to specify another provider, provider2 branch system 424 as the provider for the cross-team change request. In this manner, the modified cross-team change request 412 originally generated by consumer branch system 402 transfers responsibility for handling the original change request to provider2 branch system 424 which responds by generating a corresponding provider change request 410 to handle the request.

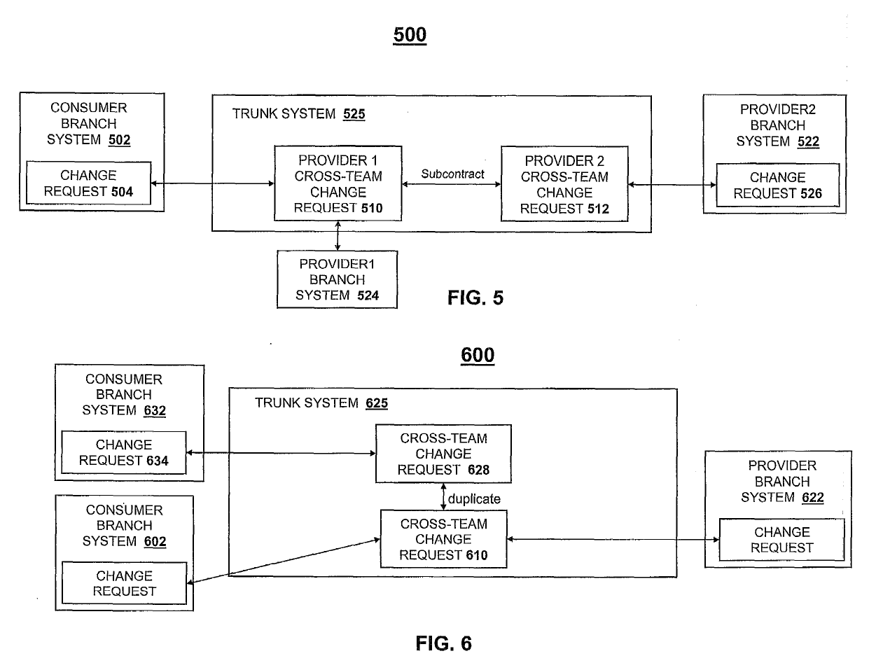

FIG. 5 is a block diagram depicting a cross-team change request architecture in accordance with the present invention. Specifically, FIG. 5 depicts a subcontract cross-team change request architecture 500 generally comprising a consumer branch system 502 and a provider branch system 522 interfaced via a trunk system 525. In the depicted embodiment, a team member and/or processing unit within consumer branch system 502 generates a change request 504 and issues a corresponding cross-team change request 510 identifying a provider1 branch system 524 as the provider. In analyzing and otherwise processing the request, provider1 branch system 524 determines that, due to the present workload of provider branch system 524 or other reasons, another provider, provider2 branch system 522, is better able to accommodate the request. In response to this determination, provider1 branch system 524 assigns or “subcontracts” the primary work required for the request to provider2 branch system 522 via a second cross-team change request 512 while maintaining ownership of the request via the original cross-team change request 510. Such subcontracting is accomplished by generating cross-team change request 512 which identifies provider branch system 522 as responsible for addressing the substance of the change request with the original cross-team change request 510 enabling the original provider branch system 524 to maintaining responsibility for oversight or secondary work associated with the request such as testing or documentation.

FIG. 6 is a block diagram illustrating a cross-team change request architecture in accordance with the present invention. Specifically, FIG. 6 depicts a duplicate change request architecture 600 generally comprising consumer branch systems 602 and 632 and a provider branch system 622 interfaced via a trunk system 625. In the depicted embodiment, consumer branch system 632 determines that a cross-team change request 610 that the consumer needs has already been issued to provider branch system 622 by consumer branch system 602. In response, a team member/processing unit within consumer branch system 632 generates a second cross-team change request 628 having a corresponding originating change request 634 for provider branch system 622 and marks request 628 as a “duplicate” of cross-team change request 610. As provider branch system 622 updates status in provider change requests associated with the original branch change request 604, both the original and duplicate consumer's branch change requests are updated with the updated provider status.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A system for providing enhanced cross-team change request management, said system comprising:
a plurality of consumer branch systems that track one or more consumer change requests;
a plurality of provider branch systems that track one or more provider change requests;
a trunk system comprising a shared database for storing cross-team change requests, said shared database accessible by said plurality of consumer branch systems and said plurality of provider branch systems;
wherein said cross-team change requests are generated by said plurality of consumer branch systems; and
wherein said provider change requests are generated by said plurality of provider team members in response to said cross-team change requests.

2. The system of claim 1, wherein said trunk system further comprises:
a first cross-team change request generated by a consumer branch system, said first cross-team change request specifying a consumer request and identifying a first provider branch system to handle the consumer request; and
a second cross-team change request that is generated by said first provider branch system, said second cross-team change request specifying a second provider branch system to substantively handle the consumer request.

3. In a data processing system having multiple logically coupled branch systems that share interdependent products and services, a system for providing enhanced cross-team change request management, said system comprising:
a consumer branch system that generates a consumer change request;
a trunk system accessible by said multiple logically coupled branch systems, wherein said trunk system manages cross-team change requests between said multiple logically coupled branch systems in a shared database, said trunk system storing a first cross-team change request that associates said consumer change request with a first provider branch system; and
wherein in response to said first provider branch system determining that a supplemental consumer change request is required to address said consumer change request, said first provider branch system generates a second cross-team change request within said trunk system, wherein said second cross-team change request associates said supplemental consumer change request with a second provider branch system.

4. The system of claim 3, wherein said determining that a supplemental consumer change request is required to address said consumer change request comprises determining in the course of processing the consumer change request that a defect fix is required from said second provider branch system.

5. The system of claim 3, wherein said first and second provider branch systems generate provider change requests in response to said first and second cross-team change requests, said provider change requests tracking implementation and processing of consumer change requests corresponding to the first and second cross-team change requests.

6. A system for providing enhanced cross-team change request management, said system comprising:
a plurality of consumer branch systems that track one or more consumer change requests;
a plurality of provider branch systems that track one or more provider change requests;
a trunk system comprising a shared database for storing cross-team change requests, said shared database accessible by said plurality of consumer branch systems and said plurality of provider branch systems;
wherein said cross-team change requests are generated by said plurality of consumer branch systems;
wherein said provider change requests are generated by said plurality of provider team members in response to said cross-team change requests;
wherein said trunk system further comprises a cross-team change request that specifies a consumer change request and identifies a first provider branch system to handle the consumer change request; and
wherein said first provider branch system modifies an existing cross-team change request or creates a new cross-team change request to specify a second provider branch system to handle the consumer change request.
